(19) United States
(12) Patent Application Publication
(10) Pub. No.: US 2019/0235354 A1
(43) Pub. Date: Aug. 1, 2019

(54) MAGNETIC CAMERA HOLSTER FOR AQUATIC ENVIRONMENTS

(71) Applicant: Garrett J. Cleary, San Diego, CA (US)

(72) Inventor: Garrett J. Cleary, San Diego, CA (US)

(21) Appl. No.: 16/237,329

(22) Filed: Dec. 31, 2018

Related U.S. Application Data
(60) Provisional application No. 62/612,673, filed on Jan. 1, 2018.

(51) Int. Cl. G03B 17/56; G03B 17/08; A45C 11/38

(52) U.S. Cl. CPC G03B 17/561; A45C 11/38; G03B 17/08; G03B 17/566

(57) ABSTRACT

A camera holster suited for securing a camera in aquatic environments includes a base that can be attached to an accessory worn by a user. The base includes an attachment mechanism for attaching to the belt or other type of accessory. The front side includes a first magnet. An interior of the base includes a spring-loaded cord with a securement device for attaching to the camera. The spring is biased to retract the cord within the base. The biasing force is small enough to enable a quick access of the camera and extension of the camera via the cord away from the base, yet strong enough to retract the camera via the cord to the base if the user lets go of the camera. The biasing force can be tailored to overcome resistance of water on the movement of the camera.

### CROSS REFERENCE TO RELATED APPLICATION

The present application claims the benefit of U.S. Provisional Patent Application No. 62/612,673, filed Jan. 1, 2018 entitled “Magnetic Camera Holster For Aquatic Environments”, the disclosure of which is incorporated herein by reference in its entirety.

### BACKGROUND

Various activities in an aquatic environment, such as scuba diving, snorkeling, spear fishing, swimming, surfing, etc., can include the use of a camera for underwater photography. Most underwater cameras are simply waterproof versions of typical cameras—they are held by one or both hands of a user, pointed at a scene and operated to take pictures. Some underwater cameras include a mount having one or handles or hand grips, but such mounts can be unwieldy and large, and usually require the user to constantly hold the mount with one or both hands.

In some cases, it is desirable, or even vital, for hands-free carriage of a camera, such as in an emergency situation or when the user needs to use their hands and arms for swimming. Current techniques for hands-free carrying of a camera include clipping or attaching the camera to a belt or clip, or mounting the camera within a holster or carrying case attached to the user. However, these techniques require time, precision and care, as doing these things in an aquatic environment, particularly in a dynamic or dangerous environment, is very challenging. If not done with precision, and the camera is untethered from the user, the camera can be lost in the water.

Further still, if a camera is properly retained to the user by a clip or holster, it is often very difficult to have quick access to the camera to take a picture of a desired scene, which can change very rapidly. Conventional camera attachment devices and techniques simply do not allow quick and accurate access to the camera when it is needed, nor do they allow proper and easy re-attachment or re-holstering.

What is needed is a camera holster that can allow for rapid and precise access to the camera by a user, secure tethering to the user whether or not being held in one or more hands by the user, and simple and fast re-attachment of the camera with the holster.

### SUMMARY

This document describes a camera holster, which is specifically suited for securing a camera in aquatic environments. The camera holster includes a base that can be attached to a belt or other type of accessory of a user. The base includes a front side and a back side. The back side includes an attachment mechanism for attaching to the belt or other type of accessory. The front side includes a first magnet. An interior of the base includes a spring-loaded cord with a securement device for attaching to a mount. The mount, in turn, is connected to the camera or a case around the camera. The spring is biased to retract the cord within the base interior. The biasing force is small enough to enable a quick access of the camera and extension of the camera via the cord away from the base, yet strong enough to retract the camera via the cord to the base if the user lets go of the camera. The biasing force can be tailored to overcome resistance of the water on the movement of the camera, particularly if the user is in motion in the water.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1A and 1B illustrates a front side and a back side of a base of a camera holster system, respectively;

FIGS. 2A and 2B illustrate a top perspective view and a bottom perspective view of a mount;

FIG. 3A is an exploded view of a magnetic camera holster system for holding a camera, particularly in aquatic environments; and

FIG. 3B shows a camera being held by a base via a mount, and in particular to corresponding attractive magnets in the base and the mount, respectively.

Like reference symbols in the various drawings indicate like elements.

### DETAILED DESCRIPTION

This document describes a camera holster system and apparatus, which is specifically suited for securing a camera in aquatic environments. In some implementations, a camera holster system includes a base and a mount. The mount includes a screw for attaching to corresponding receptacle in the camera or in a case of the camera. The base has a front side and a back side, and has an interior between the front side and the back side of the base. The interior defines a housing for containing a spring, such as a constant force spring formed of a wound-up metal coil, for example. A proximal end of the spring is rigidly attached to the housing, and a distal end of the spring is coupled with a cord.

The cord has a proximal end attached to the distal end of the spring, and a distal end having a securement mechanism. The securement mechanism can be a screw, a clip, a bolt, a pin, a latch or other type of attaching device to attach to the mount and secure the camera. In some implementations, the camera is provided with the corresponding securement mechanism to couple with the securement mechanism of the cord, such as a threaded aperture or the like. The cord can be made of a waterproof material, such as stainless steel, or plastic or rubber wrapped braided material.

The cord can be extended from and retracted back to the housing of the base. In fully or at least partially extended mode, the cord extends at a distance from the base to enable a user to hold the camera in a desired location, i.e. in front of user's face, for example. In fully or at least partially retracted mode, the cord returns the mount and camera to abut the base. The spring is biased to retract the cord within the base interior. The biasing force is small enough to enable a quick access of the camera and extension of the mount and camera via the cord away from the base, yet strong enough to retract the camera via the cord to the base if the user lets go of the camera. The biasing force can be tailored to overcome resistance of the water on the movement of the camera, particularly if the user is in motion in the water.

The front side of the base includes a first magnet, while the mount includes a second magnet. The second magnet can be embedded in the mount. When the cord is fully or at least partially retracted into the housing of the base, the second magnet of the mount will abut with the first magnet of the base to hold the camera to the base. A hole or aperture from which the cord extends from the base can be positioned on the front side or other side of the base so as to facilitate proper alignment or abutment of the first and second magnets. The front side of the base can also include one or more protrusions, ridges, indents, or other alignment features that can interact with similar feature associated with the camera, for further facilitating such alignment and abutment.

The back side of the base includes an attachment mechanism for attaching to the belt or other type of accessory worn by the user. The attachment mechanism can include one or more belt loops, for example. In other implementations, the attachment mechanism can include one or more of a clip, a latch, a pin, a screw, a bolt, a rivet, a button, and/or a hook and loop fastener.

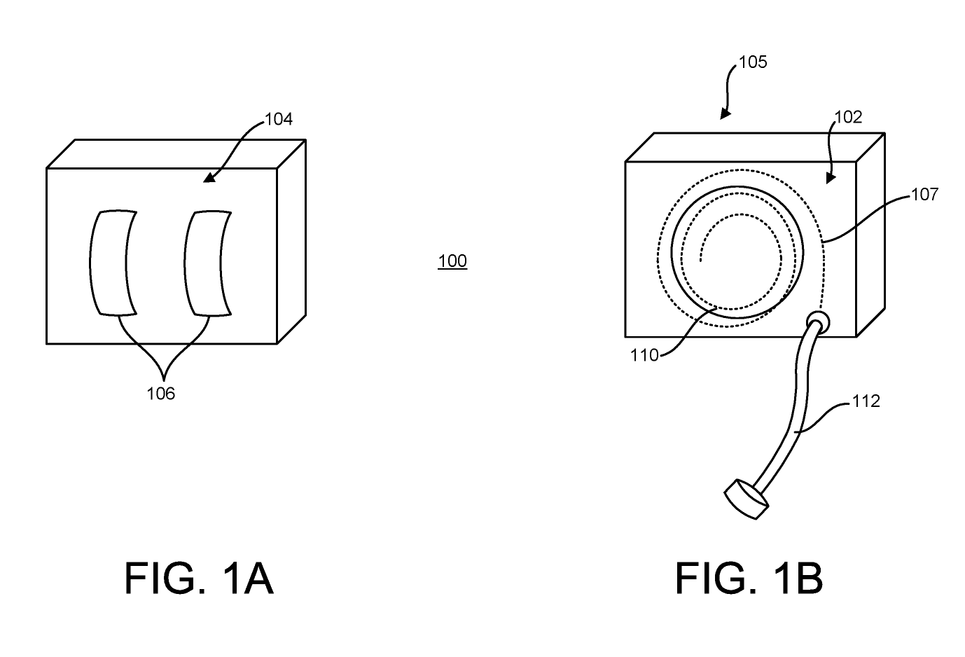

FIGS. 1A and 1B illustrates a front side 102 and a back side 104 of a base 100 of a camera holster system, respectively. The base 100 further includes an interior 105 between the front side and the back side of the base. The interior 105 defines a housing, or compartment within the interior 105. The back side 104 of the base 100 can be planar or curved, i.e. to fit snugly around a body part of a user, such as the user's waist, arm or leg. The back side 104 includes an attachment mechanism 106 for attaching to a belt or other type of accessory worn by the user. The attachment mechanism can include one or more belt loops, as shown in FIG. 1A. In other implementations, the attachment mechanism can include one or more of a clip, a latch, a pin, a screw, a bolt, a rivet, a button, and/or a hook and loop fastener, or other type of attachment mechanism.

The front side 102 of the base 100 includes a first magnet 110. The first magnet 110 can be a plate-shaped magnet, of either a squared or rounded planar shape. Alternatively, the first magnet 110 can be any other shape, such as cylindrical, conical, frustoconical, frustopyramidal, or other truncated or non-truncated shape. Preferably, a portion of the first magnet 110, such as a face or an end, is at or protrudes from the front side 102 of the base 100. For instance, if the first magnet 110 is plate-shaped, the plate magnet can form some or all of the front side 102. Alternatively, no matter what the same of the first magnet 110, the first magnet 110 can be embedded in, attached to, protruding from, or contiguous with the front side 102.

The base 100 can be made of any waterproof or water resistant, preferably rigid or semi-rigid material, such as steel, aluminum, nylon, plastic, carbon fiber, or the like.

The interior 105 of the base 100 defines a housing for containing a spring 107, shown in dotted lines, such as a constant force spring formed of a wound-up metal coil, for example. A proximal end of the spring 107 is rigidly attached to the housing, and a distal end of the spring is coupled with a cord 112. The cord 112 can be extended from and retracted back to the housing 105 of the base 100. In fully or at least partially extended mode, the cord 112 extends at a distance from the base 100 to enable a user to hold the mount and the camera in a desired location, i.e. in front of user's face, for example. In fully or at least partially retracted mode, the cord 112 returns the mount and camera to abut the base 100. The spring is biased to retract the cord within the base interior 105. The biasing force is small enough to enable a quick access of the camera and extension of the camera via the cord 112 away from the base 100, yet strong enough to retract the mount and camera via the cord 112 to the base if the user lets go of the camera. The biasing force can be tailored to overcome resistance of the water on the movement of the camera, particularly if the user is in motion in the water

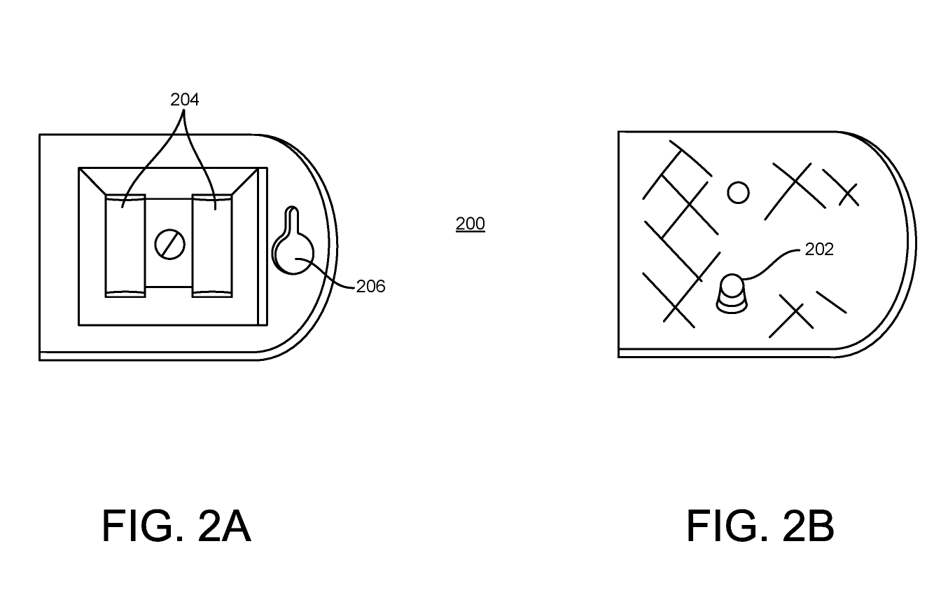

FIGS. 2A and 2B illustrate a top perspective view and a bottom perspective view of a mount 200. The mount 200 includes a screw or a bolt 202 or other mounting mechanism for mounting with a corresponding mechanism, such as a threaded aperture, for example, in a camera or a case for the camera. A bottom side of the mount 200 includes a second magnet 204. In some implementations, the bottom side of the mount 200 includes a frustopyramidal mounting structure that can be used, in some instances, for mounting on a tripod or other camera stand. The second magnet 204 can be sized and adapted to fit within or proximate to the tripod mounting structure.

The mount 200 further includes a receptacle 206 or other attachment mechanism for receiving and attaching to the cord that extends and retracts from the base, as described above.

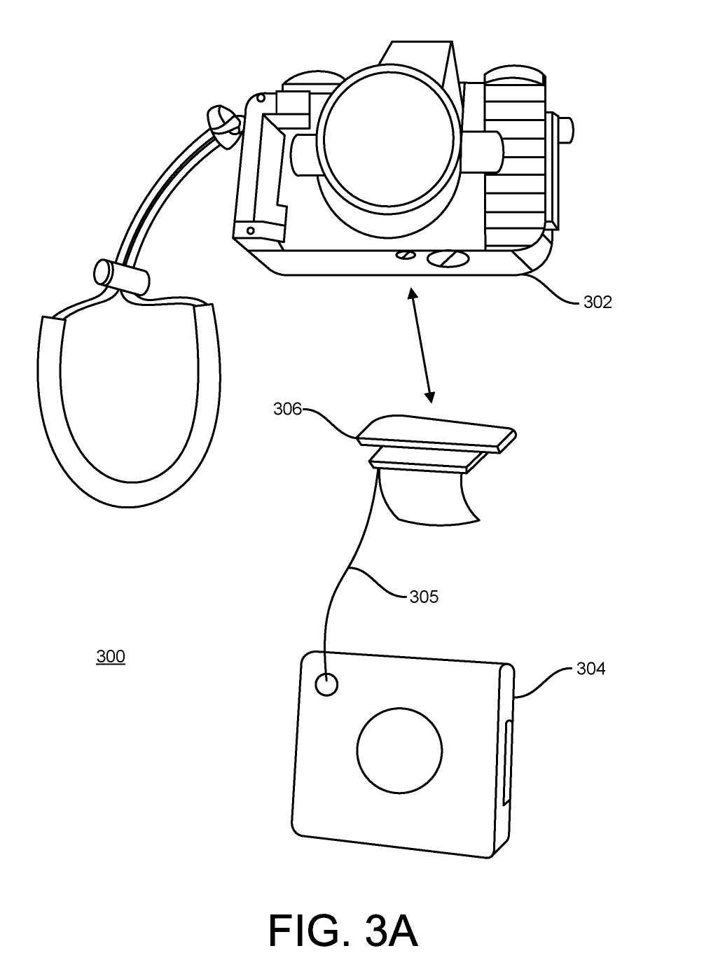

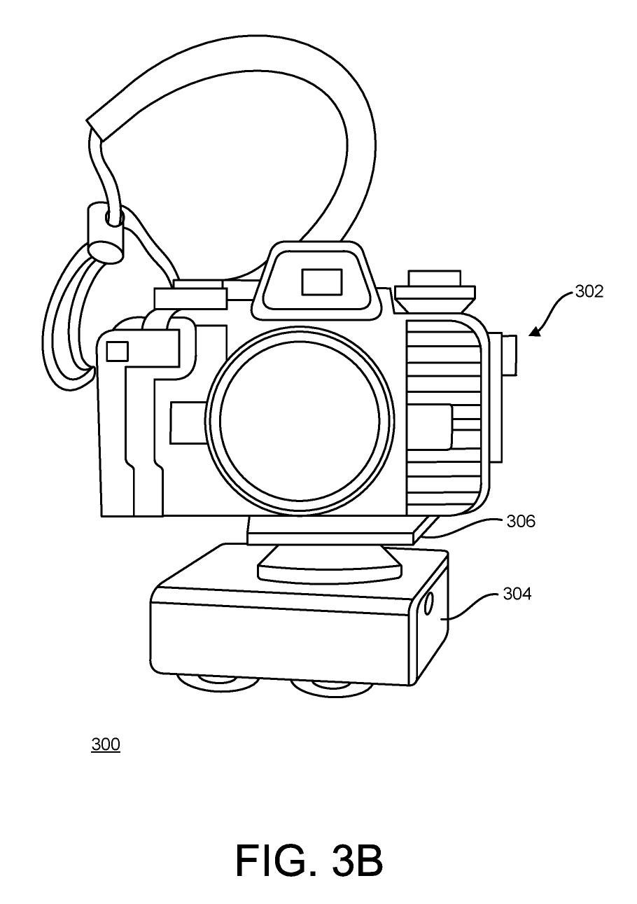

FIG. 3A is an exploded view of a magnetic camera holster system 300 for holding a camera 302, particularly in aquatic environments. The system 300 includes a base 304 and a mount 306, as described above. The mount 306 is coupled to the base 304 by a retractable cord 305. FIG. 3B shows the camera 302 being held by the base 304 via the mount 306, and in particular to corresponding attractive magnets in the base and the mount, respectively.

A front side of the base 304 includes a first magnet, while the mount 306 includes a second magnet. The second magnet can be embedded in the mount 306. When a cord is fully or at least partially retracted into a housing of the base 304, the second magnet of the mount 306 will abut with the first magnet of the base to hold the camera 302 to the base 304. A hole or aperture from which the cord extends from the base can be positioned on the front side or any other side of the base 304 so as to facilitate proper alignment or abutment of the first and second magnets. The front side of the base can also include one or more protrusions, ridges, indents, or other alignment features that can interact with similar feature associated with the camera, for further facilitating such alignment and abutment.

Although a few embodiments have been described in detail above, other modifications are possible. Other embodiments may be within the scope of the following claims.

1. A camera holster system for securing a camera to an accessory worn by a user, the system comprising:
a base having an attachment mechanism for attaching to the accessory worn by the user;
a first magnet associated with the base;
a cord that extends from the base proximate the first magnet;
a spring that biases the cord to retract into the base; and
a mount connected to a distal end of the cord that extends from the base, the mount being configured to connect with the camera to secure the camera to the cord, the mount further including a second magnet that is sized and configured to magnetically mate with the first magnet when the cord is retracted into the base by the spring, to secure the camera against the base.

2. The camera holster system in accordance with claim 1, wherein the spring is a wound-up metal coil.

3. The camera holster system in accordance with claim 1, wherein the first magnet includes a plurality of first magnets and the second magnet includes a plurality of second magnets, and wherein the plurality of first magnets and the plurality of second magnets have a magnetic polarity to secure the camera against the base in a preconfigured orientation.

4. The camera holster system in accordance with claim 1, wherein the mount includes a threaded connector to connect with the camera.

5. The camera holster system in accordance with claim 1, wherein the attachment mechanism includes a loop for attaching to the accessory worn by the user.

6. The camera holster system in accordance with claim 1, wherein the first magnet and the second magnet are adapted for aquatic environments.

7. The camera holster system in accordance with claim 1, wherein the cord is formed of a braided water-proof material.

8. The camera holster system in accordance with claim 7, wherein the braided water-proof material includes stainless steel.

9. The camera holster system in accordance with claim 1, wherein the spring is contained completely within the base.

10. A camera holster system for securing a camera to a user, the system comprising:
a belt for being worn by the user;
a base having an attachment mechanism for attaching to the belt worn by the user, the attachment;
a first magnet associated with the base;
a cord that extends from the base proximate the first magnet;
a spring that biases the cord to retract into the base; and
a mount connected to a distal end of the cord that extends from the base, the mount being configured to connect with the camera to secure the camera to the cord, the mount further including a second magnet that is sized and configured to magnetically mate with the first magnet when the cord is retracted into the base by the spring, to secure the camera against the base.
